(19) United States
(12) Patent Application Publication
(10) Pub. No.: US 2018/0088327 A1
(43) Pub. Date: Mar. 29, 2018

(54) HEAD-UP DISPLAY AND MOVING BODY EQUIPPED WITH HEAD-UP DISPLAY

(71) Applicant: Panasonic Intellectual Property Management Co., Ltd., Osaka (JP)

(72) Inventors: SATOSHI KUZUHARA, Osaka (JP); MASAFUMI SUEYOSHI, Kanagawa (JP); HIROAKI OKAYAMA, Nara (JP); KATSUHIKO HAYASHI, Nara (JP)

(21) Appl. No.: 15/830,195

(22) Filed: Dec. 4, 2017

Related U.S. Application Data
(63) Continuation of application No. PCT/JP2016/003028, filed on Jun. 23, 2016.

(30) Foreign Application Priority Data
Jun. 26, 2015 (JP) 2015-128942

(51) Int. Cl. G02B 27/01; B60K 35/00; H04N 9/31

(52) U.S. Cl. CPC G02B 27/0101; B60K 35/00; G02B 2027/014; B60K 2350/2052; G02B 2027/0145; H04N 9/3135

(57) ABSTRACT

Head-up display projects an image on transparent windshield to cause an observer to visually recognize a virtual image. Head-up display includes screen, optical system displays the image. Optical system projects the image displayed by screen on windshield. Driving unit moves screen. Optical system forms an intermediate image between optical systems, the intermediate image being larger than the image of screen.

### TECHNICAL FIELD

The present disclosure relates to a head-up display that projects an image on a reflective member having transparency to cause an observer to visually recognize a virtual image.

### BACKGROUND ART

PTL 1 discloses a display device that can perform stereoscopic display. The display device includes a display panel, an image-formation optical system, and an image-formation position variable unit. The display panel is an image forming unit that forms an image. The image-formation optical system forms the image formed by the image forming unit. The image-formation position variable unit is provided on an incident side of the image-formation optical system, and varies a position of the image formed by the image-formation optical system. The image-formation position variable unit includes a relay optical system that forms an intermediate image between the image forming unit and the image-formation optical system. The relay optical system varies the position of the intermediate image, thereby varying positions of a plurality of images sequentially switched by the image forming unit.

### CITATION LIST

### Patent Literature

PTL 1: Unexamined Japanese Patent Publication No. 2008-180759

### SUMMARY OF THE INVENTION

A head-up display of the present disclosure projects an image on a reflective member having transparency to cause an observer to visually recognize a virtual image. The head-up display includes a display, an optical system, and a driving unit. The display displays the image. The optical system projects the image displayed by the display on the reflective member. The driving unit moves the display. The optical system forms an intermediate image between optical systems, the intermediate image being larger than the image of the display.

The head-up display of the present disclosure can vary a display position of the virtual image while reducing a size.

### BRIEF DESCRIPTION OF DRAWINGS

FIG. 1 is a schematic diagram illustrating a moving body equipped with a head-up display according to the present disclosure.

FIG. 2 is a schematic diagram of an optical cross section illustrating a configuration of a head-up display according to a first exemplary embodiment.

FIG. 3 is a schematic diagram of an optical cross section illustrating a configuration of a head-up display according to a second exemplary embodiment.

FIG. 4 is a schematic diagram of an optical cross section illustrating a configuration of a head-up display according to a third exemplary embodiment.

FIG. 5 is a view illustrating eccentricity data of each plane in an optical system of Example 1 (corresponding to the first exemplary embodiment).

FIG. 6 is a view illustrating a radius of curvature of each plane in the optical system of Example 1 (corresponding to the first exemplary embodiment).

FIG. 7 is a view illustrating shape data of a free curved surface in the optical system of Example 1 (corresponding to the first exemplary embodiment).

FIG. 8 is a view illustrating the shape data of the free curved surface in the optical system of Example 1 (corresponding to the first exemplary embodiment).

FIG. 9 is a view illustrating the shape data of the free curved surface in the optical system of Example 1 (corresponding to the first exemplary embodiment).

FIG. 10 is a view illustrating eccentricity data of each plane in an optical system of Example 2 (corresponding to the first exemplary embodiment).

FIG. 11 is a view illustrating a radius of curvature of each plane in the optical system of Example 2 (corresponding to the first exemplary embodiment).

FIG. 12 is a view illustrating shape data of a free curved surface in the optical system of Example 2 (corresponding to the first exemplary embodiment).

FIG. 13 is a view illustrating the shape data of the free curved surface in the optical system of Example 2 (corresponding to the first exemplary embodiment).

FIG. 14 is a view illustrating the shape data of the free curved surface in the optical system of Example 2 (corresponding to the first exemplary embodiment).

FIG. 15 is a view illustrating data of the head-up display of Examples 1 and 2.

### DESCRIPTION OF EMBODIMENTS

Hereinafter, exemplary embodiments will be described in detail with reference to the drawings as appropriate. However, detailed description more than necessary may be omitted. For example, detailed description of a known matter or repetitive description of a substantially identical configuration may be omitted. This is to avoid the following description from becoming unnecessarily redundant, and to ease understanding of those skilled in the art.

Note that the attached drawings and the following description are provided for those skilled in the art to fully understand the present disclosure, and are not intended to limit the subject matter as described in the appended claims.

### First Exemplary Embodiment

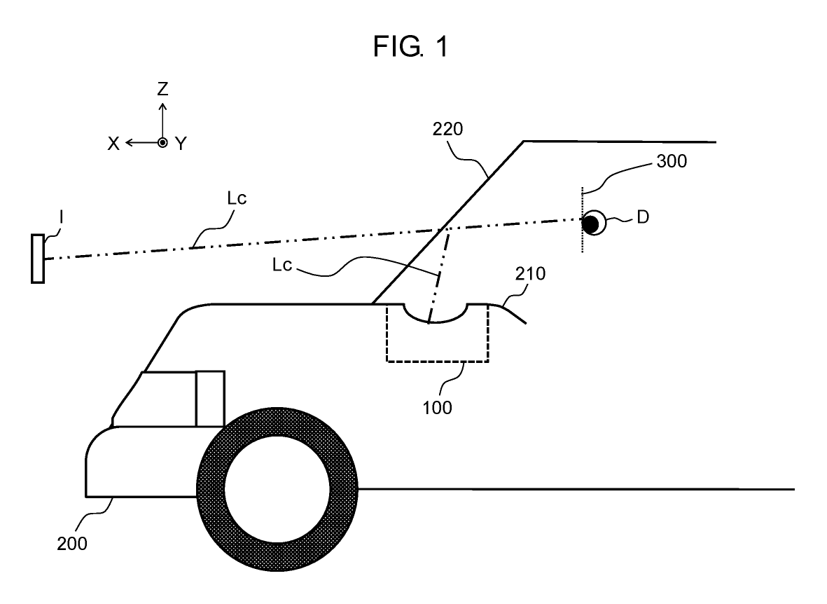

A first exemplary embodiment will be described below with reference to FIGS. 1 to 4.

[1-1. Configuration]

[1-1-1. Overall Configuration of Head-Up Display]

Specific exemplary embodiments and examples of head-up display 100 of the present disclosure will be described below with reference to the drawings.

FIG. 1 is a schematic diagram illustrating a cross section of vehicle 200 equipped with head-up display 100 according to the present disclosure. As illustrated in FIG. 1, head-up display 100 is disposed inside dashboard 210 below windshield 220 of vehicle 200. Observer D recognizes an image projected from head-up display 100 as virtual image I.

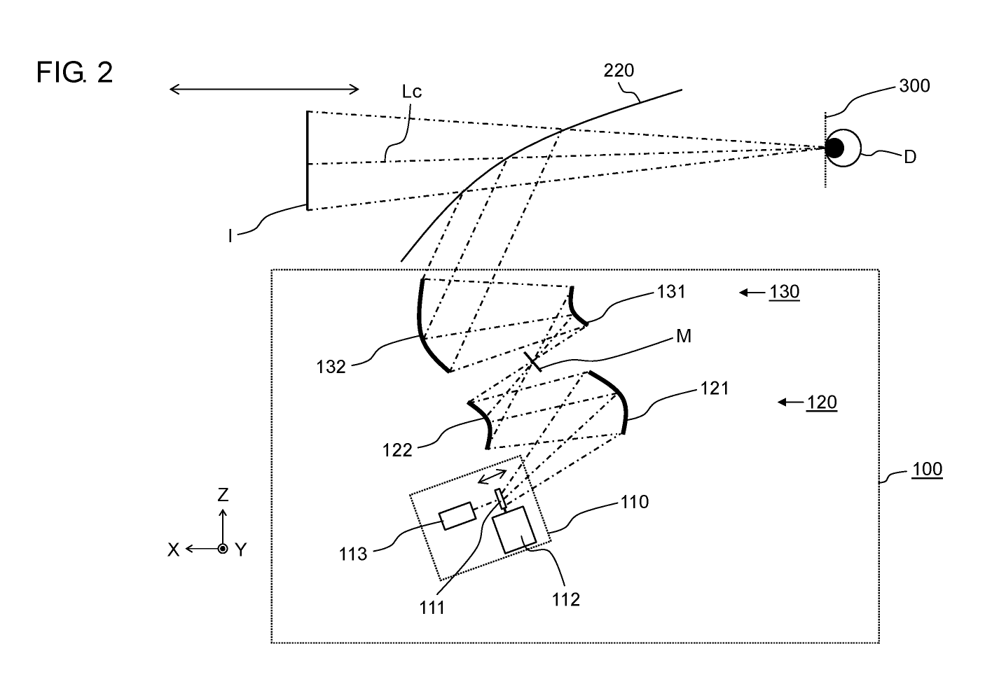

FIG. 2 is a schematic diagram of an optical cross section illustrating head-up display 100 of the first exemplary embodiment. As illustrated in FIG. 2, head-up display 100 includes display device 110, relay optical system 120, and projection optical system 130. Head-up display 100 reflects the image displayed on display device 110 through windshield 220, and guides the image to viewpoint region 300 (sometimes referred to as an eye-box) of observer D, thereby presenting virtual image I to observer D.

At this point, it is assumed that reference ray Lc is an optical path of a display image of screen 111, the optical path constituting a center of virtual image I. Actually, reference ray Lc visually recognized by observer D reaches observer D from display device 110 through an optical system. For this reason, a ray, which corresponds to reference ray Lc output from the center of virtual image I and reaches observer D from display device 110, is also referred to as reference ray Lc. Additionally, optical paths corresponding to these rays are also referred to as reference ray Lc. At this point, it is assumed that a viewpoint of observer D is located in a center of viewpoint region 300.

Display device 110 includes screen 111, driving unit 112 that drives screen 111, and scanning laser 113. In display device 110, a controller such as a microcomputer (not illustrated) controls display image information. Various pieces of information such as road traffic navigation display, a distance to a vehicle ahead, a remaining battery charge of a vehicle, and a current vehicle speed can be displayed as the display image information. A projector or a scanning laser, which projects the image on screen 111, is used as a light source for display device 110. Scanning laser 113 scans a surface of screen 111 to form a display image. Driving unit 112 is a driving device that moves screen 111 along reference ray Lc. Driving unit 112 moves screen 111 along reference ray Lc, which allows adjustment of a distance from observer D to virtual image I. For example, when screen 111 is moved away from relay optical system 120, virtual image I can be moved away from observer D.

Driving unit 112 moves according to a scanning position in screen 111 of scanning laser 113. Therefore, virtual image I can be drawn on any plane regardless of an output angle of reference ray Lc of screen 111. For example, virtual image I can be drawn on a plane inclined with respect to observer D by synchronization between a drawing cycle of scanning laser 113 and a swing cycle of screen 111. Screen 111 is moved back and forth at several tens of hertz in a direction of reference ray Lc, which allows stereoscopic display of virtual image I.

A moving amount of intermediate image M is larger than a moving amount of screen 111. This is because lateral magnification β of relay optical system 120 has magnification effect larger than 1. At this point, the moving amount of intermediate image M is moved β² times the moving amount of screen 111. Aerial image M is formed in air, but not formed in a projection plane that diffuses and reflects light.

Driving unit 112 not only moves screen 111 in an optical axis direction but also rotates or inclines screen 111.

Relay optical system 120 includes first mirror 121 and second mirror 122. Relay optical system 120 reflects the image displayed on screen 111 of display device 110 through first mirror 121, and further reflects the image through second mirror 122, thereby forming intermediate image M. At this point, intermediate image M is formed while being magnified larger than the image displayed on screen 111. That is, large intermediate image M can be obtained even if the small image is displayed on screen 111. Therefore, the size of screen 111 can be reduced. Additionally, large intermediate image M can reduce magnifying power in projection optical system 130. Therefore, positive power of the fourth mirror of projection optical system 130 can be weakened, and a screen distortion can be suppressed. Specifically, it is desirable that the power of relay optical system 120 is set so as to satisfy the following Condition (1).

1.4<β<4.0 (1)

where β is lateral magnification of relay optical system 120.

It is not necessary to form intermediate image M at an intermediate image position as a good point, but a spherical aberration, a coma aberration, a field curvature, and an astigmatism may be generated.

Projection optical system 130 includes third mirror 131 and fourth mirror 132. Projection optical system 130 reflects intermediate image M formed by relay optical system 120 through third mirror 131, and reflects intermediate image M through fourth mirror 132, thereby projecting intermediate image M on windshield 220. Aerial image M is formed in air, but not formed in a projection plane that diffuses and reflects light.

[1-1-2. Disposition Configuration of Projection Optical System, Relay Optical System, and Display Device]

In head-up display 100 of the first exemplary embodiment, display device 110 is disposed below relay optical system 120 and projection optical system 130. A display surface of screen 111 of display device 110 is oriented toward first mirror 121. At this point, it is desirable that reference ray Lc output from display device 110 is inclined with respect to the display surface of screen 111. This enables prevention of stray light, which is caused by reflection of external light entering a casing on the display surface of display device 110. Screen 111 of display device 110 is made of an optical member having a diffusion property. Scanning laser 113 that projects the image on screen 111 is disposed at the back of screen 111.

As illustrated in FIG. 2, first mirror 121 is disposed above display device 110 and on an observer D side. A reflection surface of first mirror 121 is eccentric such that the image displayed by display device 110 is reflected in second mirror 122. Second mirror 122 is disposed below first mirror 121 and on a virtual image I side. A reflection surface of second mirror 122 is eccentric such that the ray reflected from first mirror 121 is reflected in third mirror 131.

Third mirror 131 is disposed above first mirror 121. A reflection surface of third mirror 131 is eccentric such that the ray reflected from second mirror 122 is reflected in fourth mirror 132. Fourth mirror 132 is disposed on the virtual image I side with respect to third mirror 131. A reflection surface of fourth mirror 132 is eccentric such that the ray reflected from third mirror 131 is reflected in windshield 220.

A distance of reference ray Lc from first mirror 121 to second mirror 122 is shorter than a distance of reference ray Lc from third mirror 131 to fourth mirror 132. Therefore, a size of head-up display 100 can be reduced. A distance of reference ray Lc from screen 111 to first mirror 121 is shorter than a distance of reference ray Lc from first mirror 121 to intermediate image M. Therefore, downsizing of first mirror 121 can be achieved, and the size of head-up display 100 can also be reduced. An upper end of the reflection surface of first mirror 121 is located above a lower end of the reflection surface of fourth mirror 132. Therefore, the size of head-up display 100 can be reduced.

An exit pupil position of relay optical system 120 is brought close to projection optical system 130, which allows a difference in angle output from screen 111 to be reduced from a central portion to a peripheral portion of a display image region of screen 111. Therefore, a fluctuation in distortion can be suppressed when screen 111 is swung in the direction of reference ray Lc.

In relay optical system 120 of the first exemplary embodiment, the reflection surface of first mirror 121 has a concave shape. The reflection surface of second mirror 122 has a convex shape. The convex shape of second mirror 122 can satisfactorily correct an asymmetrically eccentric distortion generated in first mirror 121. The concave shape of first mirror 121 can also exert condensing effect of forming an intermediate image from the image of screen 111. Alternatively, one of first mirror 121 and second mirror 122 may be a free curved surface, and the other may be a planar mirror. Relay optical system 120 is not limited to two mirrors, i.e., first mirror 121 and second mirror 122, but relay optical system 120 may be configured by a refraction optical element, such as a lens element which has a similar effect, or configured only by first mirror 121.

In projection optical system 130 of the first exemplary embodiment, the reflection surface of third mirror 131 has a convex shape. The reflection surface of fourth mirror 132 has a concave shape. The convex shape of third mirror 131 can satisfactorily correct the asymmetrically eccentric distortion generated in fourth mirror 132. The concave shape of fourth mirror 132 allows observer D to visually recognize virtual image I magnified larger than intermediate image M.

At this point, first mirror 121 has the largest power in relay optical system 120 and projection optical system 130. Therefore, the downsizing of relay optical system 120 can be achieved.

In the first exemplary embodiment, first mirror 121, second mirror 122, third mirror 131, and fourth mirror 132 have a free curved surface shape. This is because the distortion of virtual image due to the reflection is corrected such that good virtual image I is observed over a whole region of viewpoint region 300.

[1-2. Effects and Others]

As described above, in the first exemplary embodiment, head-up display 100 includes display device 110, relay optical system 120, and projection optical system 130. The image formed by relay optical system 120 is larger than the display image display on screen 111 by display device 110. Therefore, the downsizing of display device 110 can be achieved. Because head-up display 100 includes relay optical system 120, the size of screen 111 is reduced while the screen distortion is corrected satisfactorily, and the positive power of projection optical system 130 can be suppressed.

### Second Exemplary Embodiment

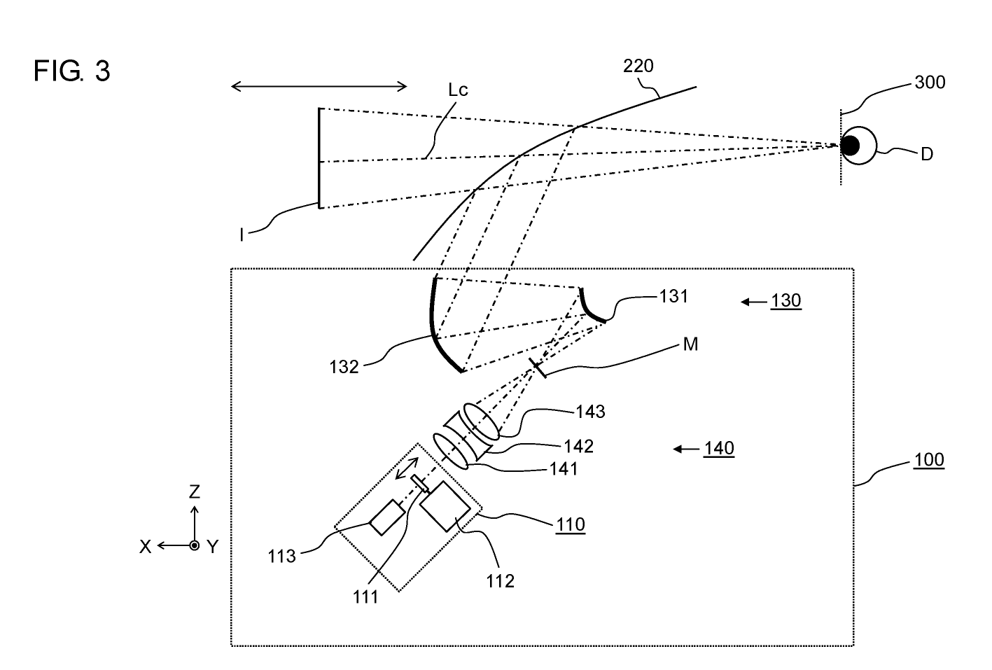

A second exemplary embodiment will be described below with reference to FIG. 3. In the second exemplary embodiment, a configuration of relay optical system 140 differs from that of relay optical system 120 of the first exemplary embodiment, and other configurations are similar to those of the first exemplary embodiment. Therefore, points different from the first exemplary embodiment will be mainly described below, and the description about the similar configuration will be omitted.

[2-1. Configuration]

[2-1-1. Overall Configuration of Head-Up Display]

FIG. 3 is a schematic diagram of an optical cross section illustrating head-up display 100 of the second exemplary embodiment.

Relay optical system 140 of the second exemplary embodiment includes first lens 141, second lens 142, and third lens 143. Relay optical system 140 has the positive power as a whole. First lens 141 is formed into a spherical shape having the positive power. Second lens 142 is formed into a spherical shape having the negative power. Third lens 143 is formed into a spherical shape having the positive power. Alternatively, one of first lens 141, second lens 142, and third lens 143 may have the free curved surface shape. Relay optical system 140 is not limited to three lenses, i.e., first lens 141, second lens 142, and third lens 143, but relay optical system 140 may be configured by four or more lenses.

The image displayed on screen 111 of display device 110 is refracted through first lens 141, refracted through second lens 142, and refracted through third lens 143, thereby forming intermediate image M. At this point, intermediate image M is formed while being magnified larger than the image displayed on screen 111. Specifically, the power of relay optical system 140 is set so as to satisfy the following Condition (1).

1.4<β<4.0 (1)

where β is lateral magnification of relay optical system 140.

Projection optical system 130 includes third mirror 131 and fourth mirror 132. Projection optical system 130 reflects intermediate image M formed by relay optical system through third mirror 131, and reflects intermediate image M through fourth mirror 132, thereby projecting intermediate image M on windshield 220.

[2-1-2. Disposition Configuration of Projection Optical System, Relay Optical System, and Display Device]

In head-up display 100 of the second exemplary embodiment, display device 110 is disposed below relay optical system 140 and projection optical system 130. The display surface of screen 111 of display device 110 is oriented toward first lens 141. At this point, it is desirable that reference ray Lc output from display device 110 is inclined with respect to the display surface of screen 111. This enables prevention of the stray light, which is caused by the reflection of the external light such as sunlight entering the casing of head-up display 100 on the display surface of screen 111. Screen 111 of display device 110 is made of an optical member having a diffusion property. Scanning laser 113 that projects the image on screen 111 is disposed at the back of screen 111.

Third mirror 131 is disposed above relay optical system 140. The reflection surface of third mirror 131 is eccentric such that the ray output from third lens 143 is reflected in fourth mirror 132. Fourth mirror 132 is disposed on the virtual image I side (a positive direction of an X-axis) with respect to third mirror 131. The reflection surface of fourth mirror 132 is eccentric such that the ray reflected from third mirror 131 is projected on windshield 220.

[2-2. Effects and Others]

As described above, in the second exemplary embodiment, head-up display 100 includes display device 110, relay optical system 140, and projection optical system 130. The image formed by relay optical system 140 is larger than the display image displayed on screen 111 by display device 110. Therefore, the downsizing of display device 110 can be achieved. Because head-up display 100 includes relay optical system 140, the size of screen 111 is reduced while the screen distortion is corrected satisfactorily, and the positive power of projection optical system 130 can be suppressed.

### Third Exemplary Embodiment

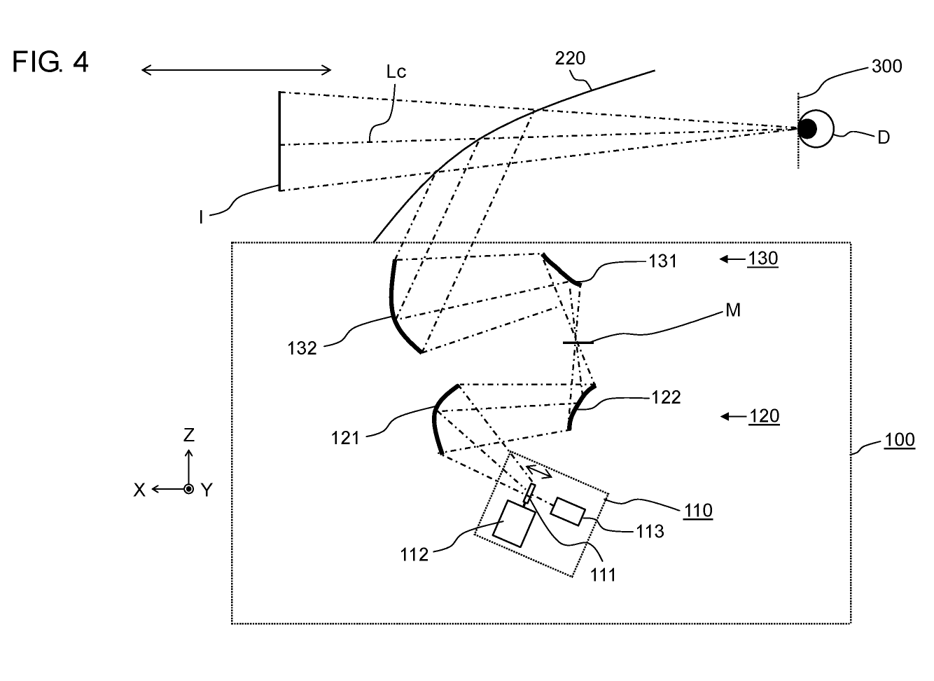

A third exemplary embodiment will be described below with reference to FIG. 4. In the third exemplary embodiment, a disposition position of relay optical system 120 differs from that of the first exemplary embodiment, and other configurations are similar to those of the first exemplary embodiment. Therefore, points different from the first exemplary embodiment will be mainly described below, and the description about the similar configuration will be omitted.

[3-1. Configuration]

[3-1-1. Disposition Configuration of Projection Optical System, Relay Optical System, and Display Device]

In head-up display 100 of the third exemplary embodiment, display device 110 is disposed below relay optical system 120 and projection optical system 130. A display surface of screen 111 of display device 110 is oriented toward first mirror 121. At this point, it is desirable that reference ray Lc output from display device 110 is inclined with respect to the display surface of screen 111. This enables prevention of the stray light, which is caused by the reflection of the external light such as the sunlight entering the casing of head-up display 100 on the display surface of screen 111. Screen 111 is made of an optical member having a diffusion property. Scanning laser 113 that projects the image on screen 111 is disposed at the back of screen 111.

First mirror 121 is disposed above display device 110 in a vertical direction (the positive direction of a Z-axis) of vehicle 200 and on the virtual image I side (the positive direction of the X-axis). The reflection surface of first mirror 121 is disposed to be eccentric such that the image displayed by display device 110 is reflected in second mirror 122. Second mirror 122 is disposed above first mirror 121 and on the observer D side (a negative direction of the X-axis). The reflection surface of second mirror 122 is disposed to be eccentric such that the ray reflected from first mirror 121 is reflected in third mirror 131.

The distance of reference ray Lc between first mirror 121 and second mirror 122 is shorter than the distance of reference ray Lc between third mirror 131 and fourth mirror 132. Therefore, a size of head-up display 100 can be reduced. The distance of reference ray Lc from screen 111 to first mirror 121 is shorter than the distance of reference ray Lc from first mirror 121 to intermediate image M. Therefore, downsizing of first mirror 121 can be achieved, and the size of head-up display 100 can also be reduced. The output side of screen 111 is oriented toward a traveling direction of vehicle 200. Therefore, scanning laser 113 can be disposed on the observer D side, and interference with a structure ahead of the vehicle can be avoided.

### Other Exemplary Embodiments

As described above, the first to third exemplary embodiments have been described as illustration of the technique disclosed in this application. However, the technique of the present disclosure is not limited to the first to third exemplary embodiments, and is applicable to exemplary embodiments where modifications, replacements, additions, omissions, and the like are appropriately made. In addition, the components described in the first to third exemplary embodiments can be combined to obtain a new exemplary embodiment.

In the first to third exemplary embodiments, the projector or the scanning laser, which projects the image on screen 111, is used as display device 110. Alternatively, the projector or the scanning laser is not used, but a liquid crystal display, an organic light emitting diode (electroluminescence), and a plasma display may be used as screen 111. Driving unit 112 is the driving device that moves screen 111 along reference ray Lc.

In the first to third exemplary embodiments, one of third mirror 131 and fourth mirror 132 may be a free curved surface and the other may be a planar mirror. Projection optical system 130 is not limited to two mirrors, i.e., third mirror 131 and fourth mirror 132, but projection optical system 130 may be configured by a refraction optical element, such as a lens element which has a similar effect, or configured only by fourth mirror 132.

In the first to third exemplary embodiments, the mirror having the rotationally asymmetrical shape is used as third mirror 131. Alternatively, third mirror 131 may have a so-called saddle type surface shape in which an X-direction differs from a Y-direction in a curvature.

In the first and third exemplary embodiments, the mirror having the rotationally asymmetrical shape is used as second mirror 122. Alternatively, second mirror 122 may have a so-called saddle type surface shape in which an X-direction differs from a Y-direction in a curvature.

The above exemplary embodiments are illustrations of the technique of the present disclosure. Therefore, various changes, replacements, additions, or omissions may be made to the exemplary embodiments within the scope of claims or their equivalents.

### NUMERICAL EXAMPLES

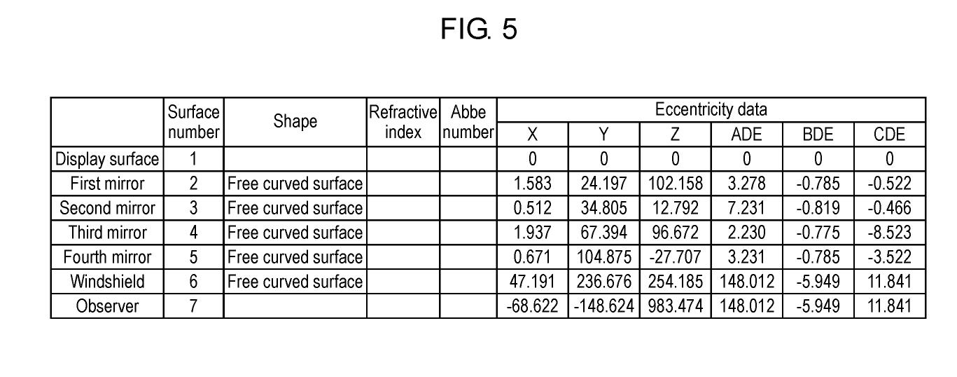

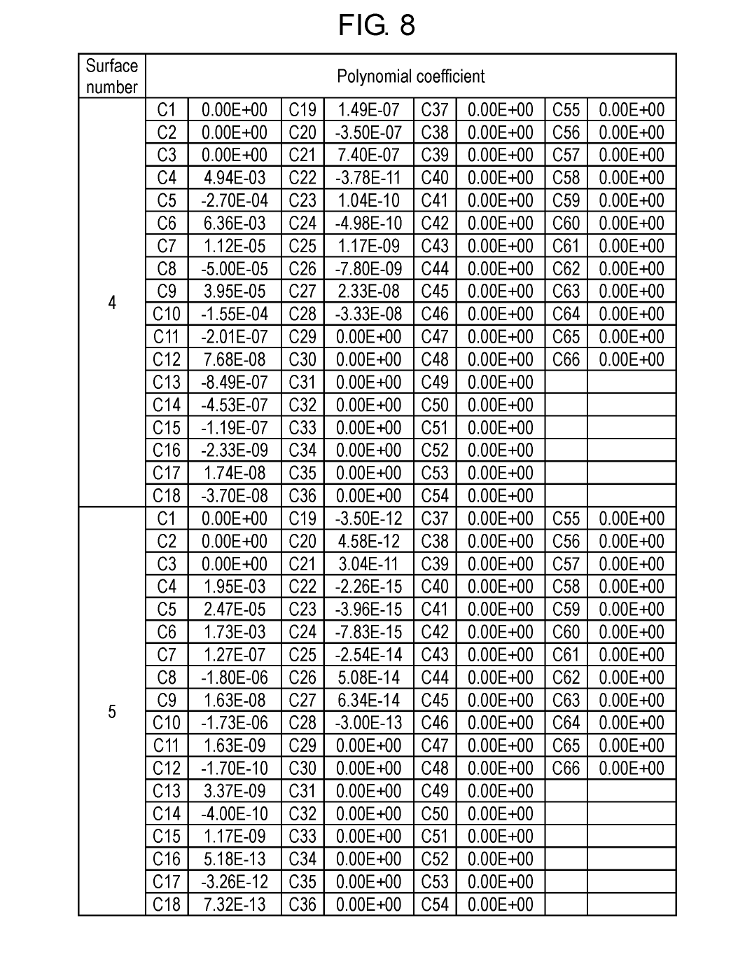

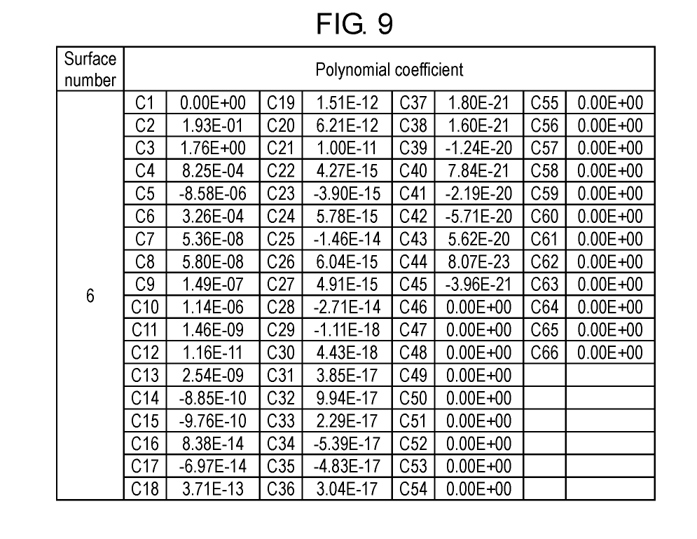

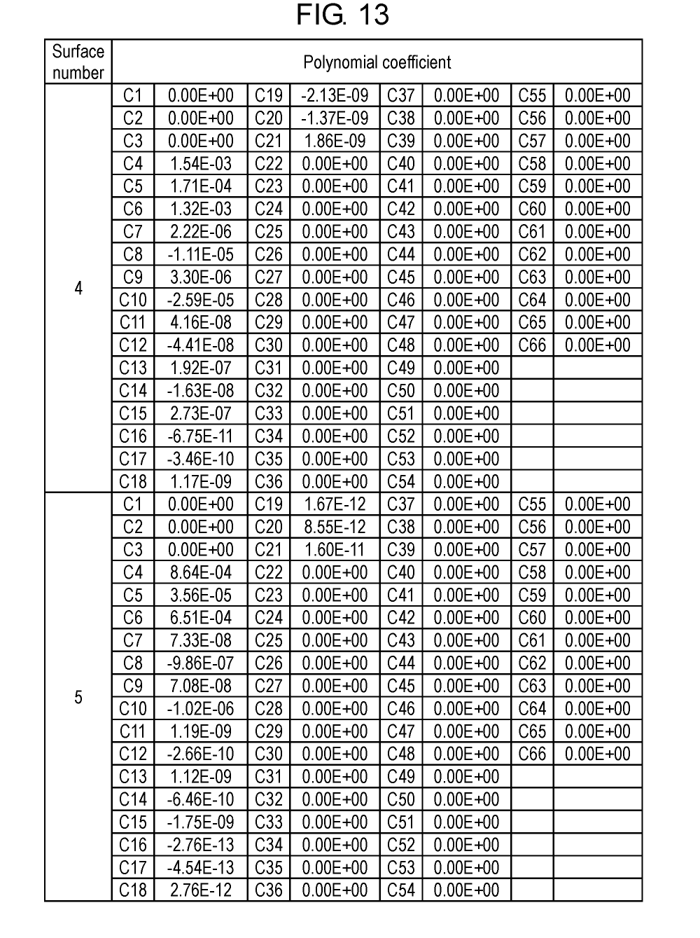

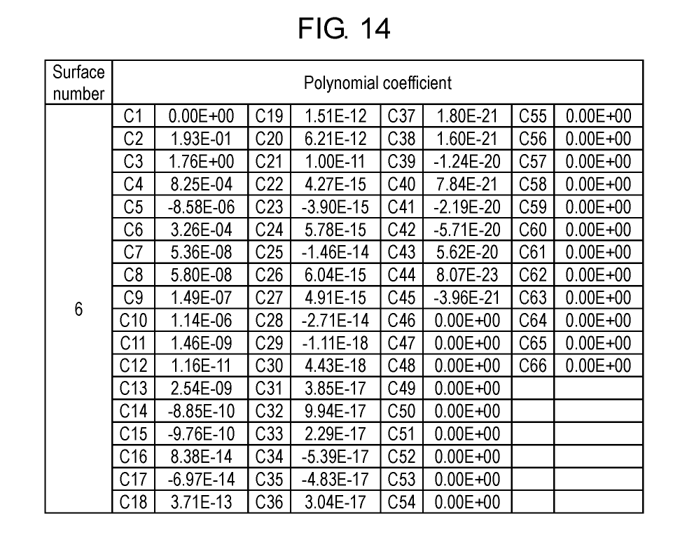

Numerical examples corresponding to the first and second exemplary embodiments will be described with reference to FIGS. 5 to 15.

Specific example of the display device according to the present technique will be described below. In the following examples, a unit of length is (mm) and a unit of angle is (degrees) in tables. A free curved surface is defined by the following Mathematical Formula 1.

$$“ Mathematical Formula 1 ”$$

$$z = \frac{{cr}^{2}}{1 + \sqrt{1 - ( 1 + k ) {c}^{2} {r}^{2}}} + {\sum }_{m , n}^{ } {C}_{j} {x}^{m} {y}^{n} ( m \geq 0 , n \geq 0 , m + n > 0 )$$

$$j = \frac{{( m + n )}^{2} + m + 3 n}{2} + 1$$

where z is a sag at position (x, y) from axes defining a surface, r is a radius of curvature at an origin on the axes defining a surface, c is a curvature at the origin on the axes defining a surface, k is a Korenich constant which corresponds to C₁ of the polynomial coefficient, and Cj is a coefficient of a monimial x^{m}yⁿ, and m and n are each an integer equal to or greater than 0.

In each of numerical examples, a coordinate origin that is a reference is the center of the image (display surface) displayed by display device 110. In the table, the X-axis indicates a horizontal direction of the display surface, the Y-axis indicates a vertical direction of the display surface, and the Z-axis indicates a direction perpendicular to the display surface.

In the eccentricity data, ADE refers to an amount of rotation of the mirror or the lens about the X-axis from the Z-axis direction to the Y-axis direction. BDE refers to an amount of rotation of the mirror or the lens about the Y-axis from the X-axis direction to the Z-axis direction. CDE refers to an amount of rotation of the mirror or the lens about the Z-axis from the X-axis direction to the Y-axis direction.

### Numerical Example 1

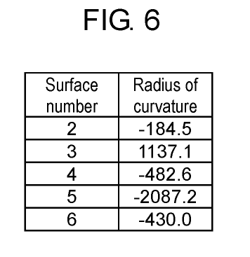

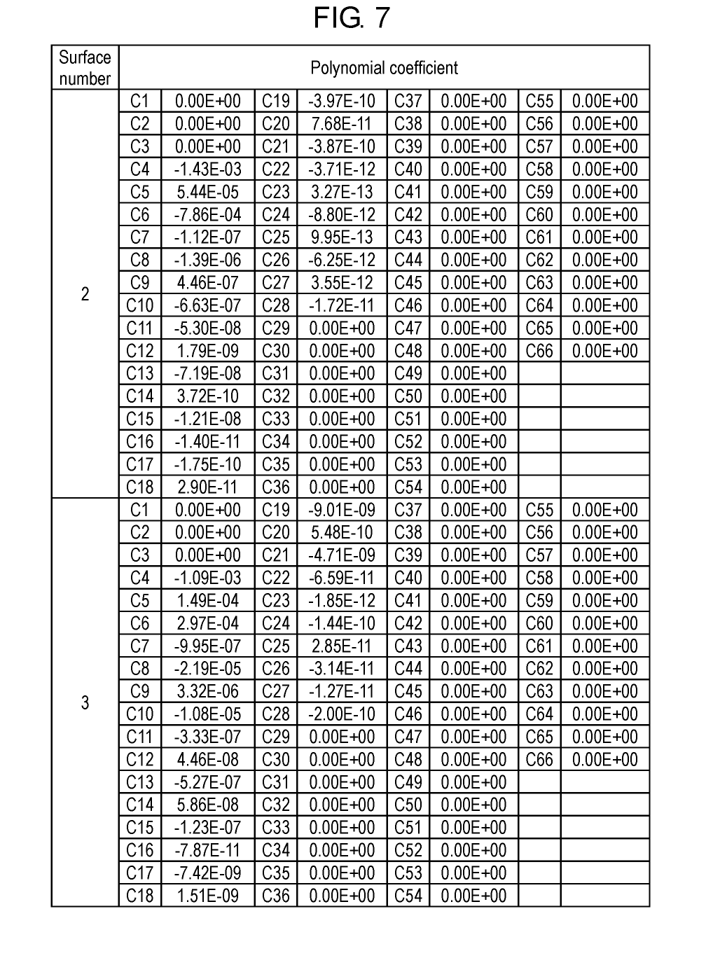

FIGS. 5 to 9 illustrate data of the optical system of head-up display 100 according to Numerical Example 1 (first exemplary embodiment). Numerical Example 1 adopts the configuration of the first exemplary embodiment. FIGS. 5 to 9 illustrate the data of the specific optical system. FIG. 5 illustrates eccentricity data of each surface in the optical element of head-up display 100. FIG. 6 illustrates a radius of curvature of each surface. FIGS. 7 to 9 illustrate a polynomial coefficient indicating the shape of the free curved surface.

### Numerical Example 2

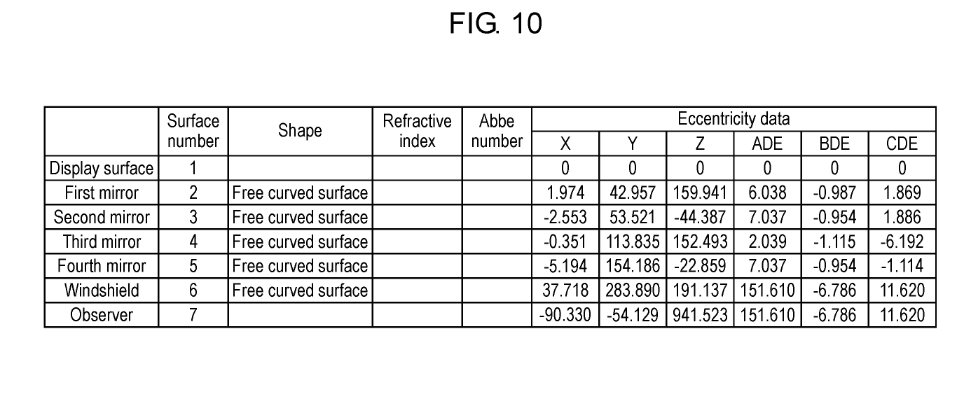

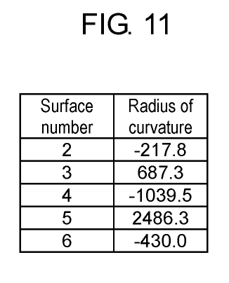

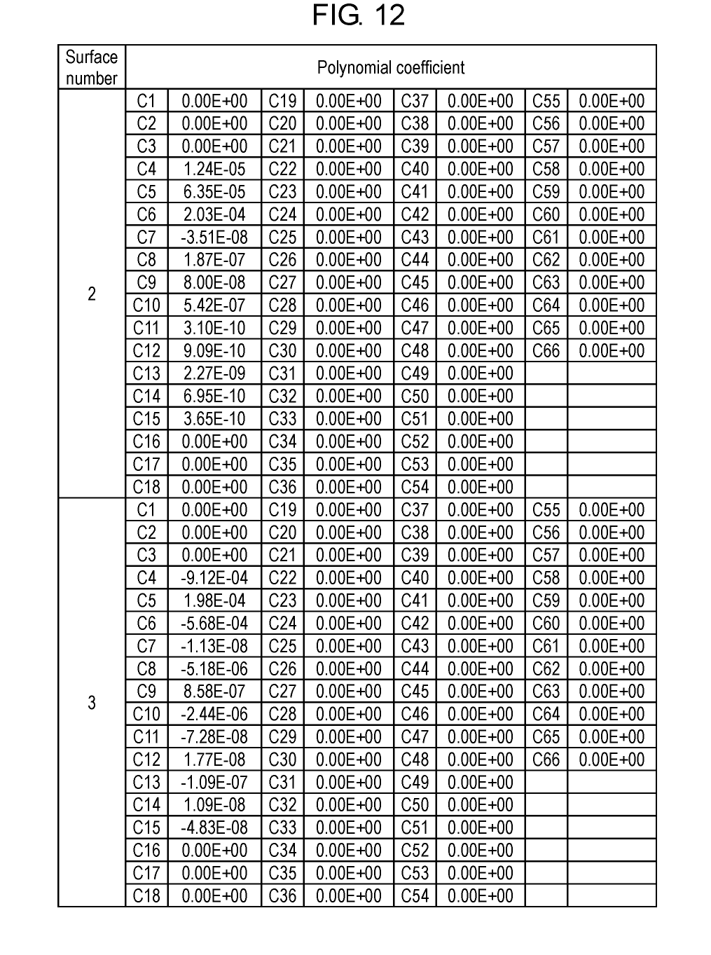

FIGS. 10 to 14 illustrate data of the optical system of head-up display 100 according to Numerical Example 2 (first exemplary embodiment). Numerical Example 2 adopts the configuration of the first exemplary embodiment. FIGS. 10 to 14 illustrate the data of the specific optical system. FIG. 10 illustrates the eccentricity data of each surface in the optical element of head-up display 100. FIG. 11 illustrates the radius of curvature. FIGS. 12 to 14 illustrate the polynomial coefficient indicating the shape of the free curved surface.

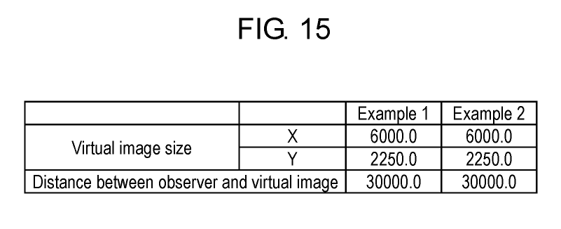

FIG. 15 illustrates a size of virtual image I of Examples 1 and 2 and a distance from observer D to virtual image I.

Table 1 illustrates corresponding values of Conditional Expression (1) of the first and second exemplary embodiments.

TABLE 1

| | EXAMPLE 1 | EXAMPLE 2 |
|---|---|---|
| CONDITIONAL EXPRESSION (1) | 1.73 | 2.29 |

### INDUSTRIAL APPLICABILITY

The present disclosure is applicable to a head-up display that projects the image on a reflection transparent member. Specifically, the present disclosure is applicable to the head-up display mounted on the moving body including the windshield.

### REFERENCE MARKS IN THE DRAWINGS

100 head-up display
110 display device
111 screen
112 driving unit
113 scanning laser
120 relay optical system
121 first mirror
122 second mirror
130 projection optical system
131 third mirror
132 fourth mirror
140 relay optical system
141 first lens
142 second lens
143 third lens
200 vehicle
210 dashboard
220 windshield
300 viewpoint region

1. A head-up display that projects an image on a reflective member having transparency to cause an observer to visually recognize a virtual image, the head-up display comprising:
a display that displays the image;
an optical system that projects the image displayed by the display on the reflective member; and
a driving unit that moves the display,
wherein the optical system forms an intermediate image formed in air in the optical system, the intermediate image being larger than the image of the display.

2. The head-up display according to claim 1, wherein a moving amount of the display is smaller than a moving amount of the intermediate image associated with the movement of the display.

3. The head-up display according to claim 2, wherein
the display displays the image by scanning of light emitted from a light source, and
the driving unit moves according to a scanning position of the display.

4. The head-up display according to claim 3, wherein
the optical system includes a relay optical system that forms the intermediate image from the image of the display, and
a projection optical system that projects the intermediate image on the reflective member.

5. The head-up display according to claim 2, wherein
the optical system includes a relay optical system that forms the intermediate image from the image of the display, and
a projection optical system that projects the intermediate image on the reflective member.

6. The head-up display according to claim 1, wherein
the display displays the image by scanning of light emitted from a light source, and
the driving unit moves according to a scanning position of the display.

7. The head-up display according to claim 6, wherein
the optical system includes a relay optical system that forms the intermediate image from the image of the display, and
a projection optical system that projects the intermediate image on the reflective member.

8. The head-up display according to claim 1, wherein
the optical system includes a relay optical system that forms the intermediate image from the image of the display, and
a projection optical system that projects the intermediate image on the reflective member.

9. The head-up display according to claim 1, satisfying the following Conditional Expression (1):
1.4<β<4.0 (1)
where β is lateral magnification of a relay optical system.

10. A moving body comprising a head-up display that projects an image on a reflective member having transparency to cause an observer to visually recognize a virtual image,
wherein the head-up display includes:
a display that displays the image;
an optical system that projects the image displayed by the display on the reflective member; and
a driving unit that moves the display, and
the optical system forms an intermediate image formed in air in the optical system, the intermediate image being larger than the image of the display.
